(19) United States
(12) Patent Application Publication
(10) Pub. No.: US 2015/0249310 A1
(43) Pub. Date: Sep. 3, 2015

(54) Electrical Extension Adapter

(71) Applicant: Doug Mclaughlin, Silver Gate, MT (US)

(72) Inventor: Doug Mclaughlin, Silver Gate, MT (US)

(21) Appl. No.: 14/635,449

(22) Filed: Mar. 2, 2015

Related U.S. Application Data
(60) Provisional application No. 61/946,288, filed on Feb. 28, 2014.

(51) Int. Cl. H01R 31/06

(52) U.S. Cl. CPC H01R 31/06; H01R 2105/00

(57) ABSTRACT

An electrical extension adapter for use with an outlet is provided. The electrical extension adapter includes a vertically extending rectangular housing having a base and an angled front face. A plurality of socket members are staggered on the angled front face of the housing. The socket members are opposedly disposed on the angled front face. The base includes a set of contact blades extending therefrom for insertion into the outlet. A pair of opposedly angled electrical extension adapters are provided to enable a pair of devices to be utilized together without blocking the insertion of plugs therein to conserve space.

### CROSS REFERENCE TO RELATED APPLICATION

This application claims the benefit of U.S. Provisional Application No. 61/946,288 filed on Feb. 28, 2014. The above identified patent application is herein incorporated by reference in its entirety to provide continuity of disclosure.

### FIELD OF THE INVENTION

The invention generally relates to an electrical adapter. More specifically, the present invention relates to an electrical extension adapter including a vertically extending rectangular housing having a base and an angled front face with a plurality of socket members disposed on the angled front face. The electrical extension adapter increases the number of electrical devices that are capable of receiving power from a single outlet.

### BACKGROUND OF THE INVENTION

Wall-mounted electrical receptacle adapters have long been used for supplying power to various types of electrical devices and appliances, such as refrigerators, fans, computers, and the like. One common issue with these electrical devices in residential, commercial and industrial environments, is the way the electrical plugs are inserted into the wall outlet receptacles for receiving electrical power. Typically, the power cable and plug extend toward the wall outlet from the backside of an electrical device. The power cable is typically longer than the distance needed for making electrical connection to the wall outlet, and its extra length is usually placed on the floor near the wall outlet receptacle. The power cable plug then rises up from the floor and is inserted into the wall outlet receptacle. The resulting angle formed by the horizontal plug insertion and the nearly vertical cable rising from the floor is sharp and is close to ninety degrees.

Often times, the forces exerted on this bent cable by itself, electrical equipment, a computer stand or table would over time cause the cable to be damaged physically and disconnected electrically whereby significantly reducing the operational life of this power cable. The problem is compounded for those power cables having thick and heavy sheathing and insulation where the angle formed as described close to the power plug is made particularly sharp due to the cable stiffness.

Additionally, the lack of space is often a limiting factor in extension adapter size and configuration. Typical computing equipment users do not leave enough space for the power cables to plug into the wall outlet receptacles. People often utilize a system of surge protectors, extension cords, and various additional hardware to keep a large number of electrical items plugged in at once. Many electronic devices feature large casings around the prongs, which can take excessive space and cover an adjacent socket, thereby rendering the socket inaccessible.

Thus, there is a continuing need for an improved electrical extension adapter that prevents physical wearing of a cable wire and provides additional outlets that enable an individual to increase the number of electrical devices that are capable of receiving power, without obstructing adjacent outlets.

### SUMMARY OF THE INVENTION

In view of the foregoing disadvantages inherent in the known types of electrical adapters now present in the prior art, the present invention provides a new and improved electrical extension adapter wherein the same can be utilized for providing convenience for the user when connecting multiple electronic devices to a single power outlet.

It is therefore an object of the present invention to provide a new and improved electrical extension adapter for increasing the number of electrical devices that are capable of receiving power from an outlet that has all of the advantages of the prior art and none of the disadvantages.

It is another object of the present invention to provide an electrical extension adapter configured to be used with a wall outlet or an outlet located on a power strip. The electrical extension adapter includes a vertically extending rectangular housing having a base and an angled front face. The angled front face enables a plurality of devices to connect to the electrical extension adapter without obstructing other outlets.

It is yet another object of the present invention to provide an electrical extension adapter with a front face including a plurality of socket members disposed on the angled front face of the housing. The front face may include an upper portion and a lower portion, each portion including socket members. The socket members on the upper portion opposedly face the socket members on the lower portion.

Another object of the present invention is to provide an electrical extension adapter wherein the base includes a set of contact blades extending therefrom for insertion into an outlet. The base is parallel with the outlet when the contact blades are engaged with the outlet.

Yet another object of the present invention is to provide a pair of complementary electrical extension adapters that include contact blades of opposing orientation to enable the devices to be utilized together without blocking insertion of plugs therein.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the electrical extension adapter according to one embodiment of the present invention.

FIG. 2 shows a perspective view of a pair of corresponding electrical extension adapters connected to a wall outlet according to one embodiment of the present invention.

FIG. 3 shows a perspective view of a pair of corresponding electrical extension adapters connected to a power strip according to one embodiment of the present invention.

### DETAILED DESCRIPTION OF THE INVENTION

Reference is made herein to the attached drawings. Like reference numerals are used throughout the drawings to depict like or similar elements of the electrical extension adapter. For the purposes of presenting a brief and clear description of the present invention, the preferred embodiment will be discussed as used for providing a complementary pair of electrical adapters for wall outlets and power strips. The figures are intended for representative purposes only and should not be considered to be limiting in any respect.

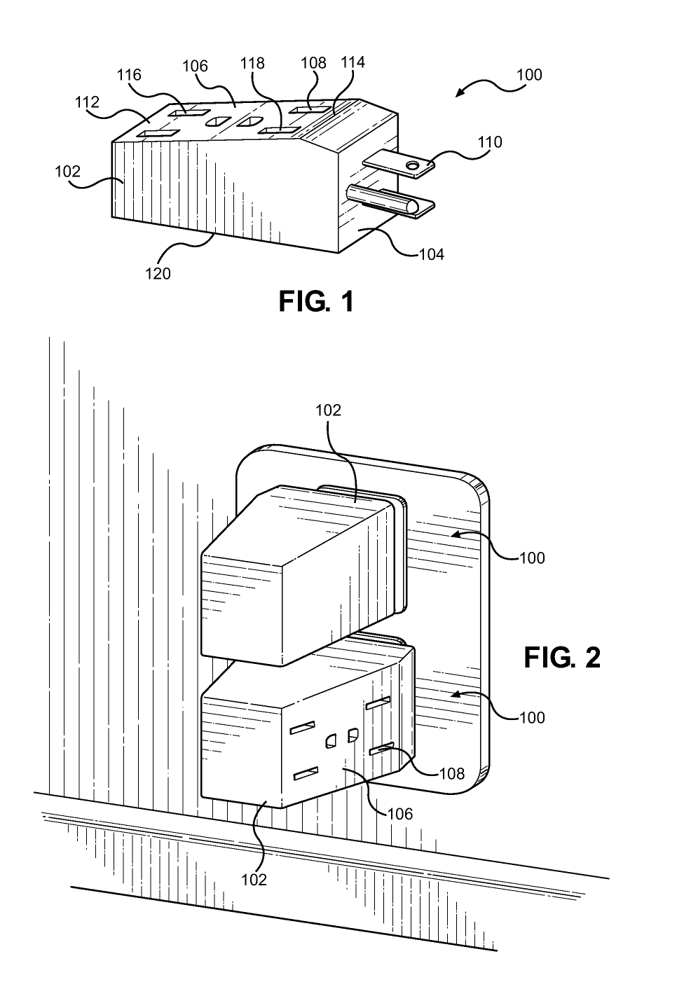

Referring now to FIG. 1, there is shown a perspective view of the electrical extension adapter according to one embodiment of the present invention. The electrical extension adapter 100 is configured to be used with a wall outlet or an outlet located on a power strip. The electrical extension adapter 100 includes a vertically extending rectangular housing 102. The rectangular housing 102 includes a base 104 and an angled front face 106. The housing 102 tapers from the base towards the outer end. The front face 106 is angled relative to the rear face of the housing 102. In one embodiment, the housing 102 comprises an upstanding plastic housing with prongs, or contact blades, 110 extending out from the base 104. The prongs 110 are adapted to plug into an electric socket and for receiving an electric current therefrom. The housing 102 extends outwardly from an outlet, thereby preserving space.

A plurality of socket members 108 are disposed on the angled front face 106 of the housing 102. In one embodiment, the first adapter socket member 116 and the second adapter socket 118 are configured in a slanted manner relative to the backside surface 120 of the adapter. The housing 102 tapers from the base of housing 102 to the top of the housing 102 to form the angled front face 106. A preferred angle measure for angled front face 106 is about 50 degrees, but a range of angle measures may be adapted for the varying sizes of the electrical plugs. The angled orientation of the sockets helps to reduce the bending of power cables secured thereto, so as to minimizes damage to power cable while also providing an advantage of space saving behind the electrical and computer equipment.

The base 104 includes a set of contact blades 110 extending therefrom for insertion into a power outlet. The base 104 is parallel with the outlet. The contact blades 110 include an electrical path and circuitry for passing the power from a wall outlet through the receptacle adapter to the inserted the power plugs well known by the artisans and therefore it is not illustrated here. Typical additions to the receptacle adapters such as power LED and surge protection circuit may also be included inside the described embodiments. The housing of the receptacle adapter may be composed of plastics or composite materials. Any lightweight plastic having adequate heat- resistant or fire-retardant characteristics are preferred.

According to one embodiment of the present invention, the front face 106 includes an upper portion 112 and a lower portion 114. The upper portion 112 and lower portion 114 each include socket members 108. The socket members 108 on the upper portion 112 opposedly face the socket members 108 on the lower portion 114. The front face 106 includes at least two opposedly facing socket members 108, thereby enabling the use of a plurality of devices.

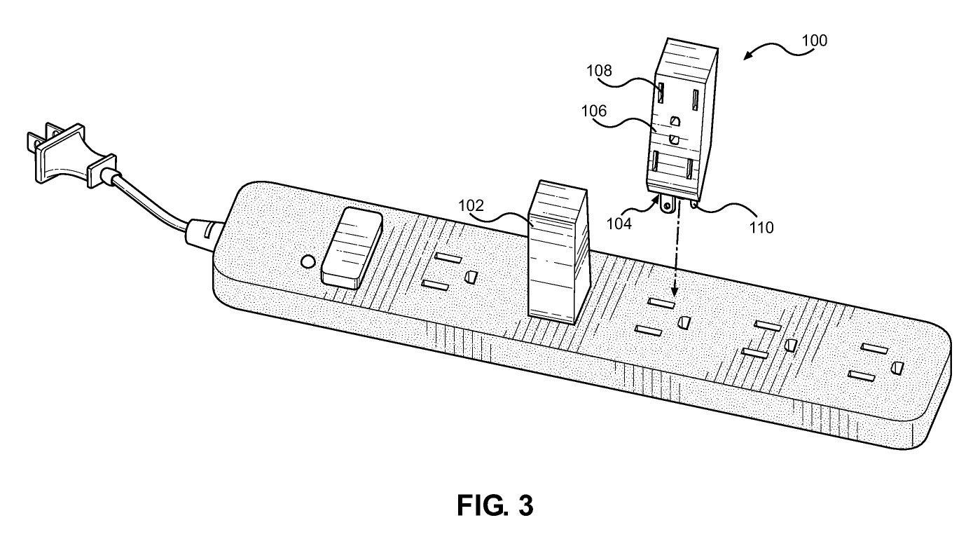

Referring now to FIGS. 2 and 3, there are shown perspective views of complementary electrical extension adapters removably connected to a wall outlet and a power strip, respectively. The electrical extension adapter 100 includes a pair of opposedly angled electrical extension adapters 100, each adapter including a vertically extending rectangular housing 102 having a base and an angled front face 106. A plurality of socket members 108 are arranged on the angled front face 106 of the housing 102. The base 104 includes a set of contact blades 110 extending therefrom for insertion into the outlet.

The electrical extension adapters 100 are opposedly angled to enable the adapters to be utilized in tandem. A user than can then plug more items into the outlet area without multiple devices overlapping. The tandem electrical extension adapters 100 provide additional outlets without occupying additional space on a wall or surge protector. Additionally, the angled front face 106 allows the cable plugs to naturally and orderly extend downward to the ground without making the sharp angles, whereby lengthening the operational life of the power cables

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An electrical extension adapter for use with a power outlet, comprising:
a vertically extending rectangular housing having a base and an angled front face;
a plurality of socket members disposed on the angled front face of the housing;
wherein the base includes a set of contact blades extending therefrom for insertion into outlet power outlet.

2) The electrical extension adapter of claim 1, wherein the front face includes a plurality of opposedly facing socket members.

3) The electrical extension adapter of claim 1, wherein the base is planar so as to rest flush against a power outlet.

4) The electrical extension adapter of claim 1, wherein the front face further comprises an upper portion and a lower portion having socket members thereon.

5) The electrical extension adapter of claim 4, wherein the socket members on the upper portion opposedly face the socket members on the lower portion.

6) An electrical extension adapter for use with an outlet, comprising:
a pair of opposedly angled electrical extension adapters, each adapter including a vertically extending rectangular housing having a base and an angled front face;
a plurality of socket members arranged on the angled front face of the housing;
wherein the base includes a set of contact blades extending therefrom for insertion into the outlet.
